(19) United States
(12) Patent Application Publication
(10) Pub. No.: US 2026/0234995 A1
(43) Pub. Date: Aug. 13, 2026

(54) DRILL BIT CUTTER ELEMENTS WITH ONE OR MORE TEXTURED, NON-PLANAR SURFACES ON CUTTING FACES THEREOF AND DRILL BITS INCLUDING SAME

(71) Applicant: National Oilwell Varco, L.P., Houston, TX (US)

(72) Inventor: Richard Rivera, Jr., Conroe, TX (US)

(73) Assignee: National Oilwell Varco, L.P., Houston, TX (US)

(21) Appl. No.: 19/153,953

(22) PCT Filed: Jan. 30, 2024
(86) PCT No.: PCT/US2024/013533

§ 371 Date: Aug. 5, 2025

Related U.S. Application Data
(60) Provisional application No. 63/443,485, filed on Feb. 6, 2023.

(51) Int. Cl. E21B 10/55; E21B 10/567

(52) U.S. Cl. CPC E21B 10/55; E21B 10/5673

(57) ABSTRACT

A cutter element for a drill bit includes a base portion having a central axis, a first end, a second end, and a radially outer surface extending axially from the first end to the second end. In addition, the cutter element includes a cutting layer fixably mounted to the first end of the base portion. The cutting layer includes a cutting face distal the base portion and a radially outer surface extending axially from the cutting face to the radially outer surface of the base portion. The cutting face includes a non-planar surface. The non-planar surface includes a surface finish including a plurality of elongate raised ridges and a plurality of recesses positioned between the raised ridges.

### CROSS-REFERENCE TO RELATED APPLICATIONS

This application is a 35 U.S.C. § 371 national stage application of PCT/US2024/013533 filed Jan. 30, 2024, and entitled “Drill Bit Cutter Elements with One or More Textured, Non-Planar Surfaces on Cutting Faces Thereof and Drill Bits Including Same,” which claims benefit of U.S. provisional patent application Ser. No. 63/443,485 filed Feb. 6, 2023, and entitled “Drill Bit Cutter Elements with One or More Textured, Non-Planar Surfaces on Cutting Faces Thereof and Drill Bits Including Same,” each of which is hereby incorporated herein by reference in its entirety for all purposes.

### STATEMENT REGARDING FEDERALLY SPONSORED RESEARCH OR DEVELOPMENT

Not applicable.

### BACKGROUND

The disclosure relates generally to drill bits for drilling a borehole in an earthen formation for the ultimate recovery of oil, gas, or minerals. More particularly, the disclosure relates to cutter elements with cutting faces including one or more non-planar surfaces with surface finishes.

An earth-boring drill bit is typically mounted on the lower end of a drill string and is rotated by rotating the drill string at the surface or by actuation of downhole motors or turbines, or by both methods. With weight applied to the drill string, the rotating drill bit engages the earthen formation and proceeds to form a borehole along a predetermined path toward a target zone. The borehole thus created will have a diameter generally equal to the diameter or “gage” of the drill bit.

Fixed cutter bits, also known as rotary drag bits, are one type of drill bit commonly used to drill boreholes. Fixed cutter bit designs include a plurality of blades angularly spaced about the bit face. The blades generally project radially outward along the bit body and form flow channels there between. In addition, cutter elements are often grouped and mounted on several blades. The configuration or layout of the cutter elements on the blades may vary widely, depending on a number of factors. One of these factors is the formation itself, as different cutter element layouts engage and cut the various strata with differing results and effectiveness.

The cutter elements disposed on the several blades of a fixed cutter bit are typically formed of extremely hard materials and include a layer of polycrystalline diamond (“PCD”) material. In the typical fixed cutter bit, each cutter element or assembly comprises an elongate and generally cylindrical support member which is received and secured in a pocket formed in the surface of one of the several blades. In addition, each cutter element typically has a hard cutting layer of polycrystalline diamond or other superabrasive material such as cubic boron nitride, thermally stable diamond, polycrystalline cubic boron nitride, or ultrahard tungsten carbide (meaning a tungsten carbide material having a wear-resistance that is greater than the wear-resistance of the material forming the substrate) as well as mixtures or combinations of these materials. The cutting layer is exposed on one end of its support member, which is typically formed of tungsten carbide. For convenience, as used herein, the phrase “polycrystalline diamond cutter” or “PDC” may be used to refer to a fixed cutter bit (“PDC bit”) or cutter element (“PDC cutter element”) employing a hard cutting layer of polycrystalline diamond or other superabrasive material such as cubic boron nitride, thermally stable diamond, polycrystalline cubic boron nitride, or ultrahard tungsten carbide.

While the bit is rotated, drilling fluid is pumped through the drill string and directed out of the face of the drill bit. The fixed cutter bit typically includes nozzles or fixed ports spaced about the bit face that serve to inject drilling fluid into the flow passageways between the several blades. The flowing fluid performs several important functions. The fluid removes formation cuttings from the bit's cutting structure. Otherwise, accumulation of formation materials on the cutting structure may reduce or prevent the penetration of the cutting structure into the formation. In addition, the fluid removes cut formation materials from the bottom of the hole. Failure to remove formation materials from the bottom of the hole may result in subsequent passes by cutting structure to re-cut the same materials, thereby reducing the effective cutting rate and potentially increasing wear on the cutting surfaces. The drilling fluid and cuttings removed from the bit face and from the bottom of the hole are forced from the bottom of the borehole to the surface through the annulus that exists between the drill string and the borehole sidewall. Further, the fluid removes heat, caused by contact with the formation, from the cutter elements in order to prolong cutter element life. Thus, the number and placement of drilling fluid nozzles, and the resulting flow of drilling fluid, may significantly impact the performance of the drill bit.

Without regard to the type of bit, the cost of drilling a borehole for recovery of hydrocarbons may be very high and is proportional to the length of time it takes to drill to the desired depth and location. The time required to drill the well, in turn, is greatly affected by the cutting efficiency and durability of the cutting structure on the drill bit.

### BRIEF SUMMARY OF THE DISCLOSURE

A cutter element for a drill bit configured to drill a borehole in a subterranean formation comprises a base portion having a central axis, a first end, a second end, and a radially outer surface extending axially from the first end to the second end. In addition, the cutter element comprises a cutting layer fixably mounted to the first end of the base portion. The cutting layer includes a cutting face distal the base portion and a radially outer surface extending axially from the cutting face to the radially outer surface of the base portion. The cutting face includes a non-planar surface. The non-planar surface comprises a surface finish including a plurality of elongate raised ridges and a plurality of recesses positioned between the raised ridges.

A cutter element for a drill bit configured to drill a borehole in a subterranean formation comprises a base portion having a central axis, a first end, a second end, and a radially outer surface extending axially from the first end to the second end. In addition, the cutter element comprises a cutting layer fixably mounted to the first end of the base portion. The cutting layer includes a cutting face distal the base portion and a radially outer surface extending axially from the cutting face to the radially outer surface of the base portion. The cutting face includes a non-planar surface. The non-planar surface includes a surface finish comprising a plurality of elongate raised ridges arranged in a plurality of laterally spaced parallel rows. Further, the surface finish comprises a plurality of first recesses. Each first recess is positioned between a pair of laterally adjacent rows. Moreover, the surface finish comprises a plurality of second recesses. Each second recess is positioned between a pair of raised ridges in each row.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of the preferred embodiments of the disclosure, reference will now be made to the accompanying drawings in which:

FIG. 1 is a schematic view of a drilling system including an embodiment of a drill bit with a plurality of cutter elements in accordance with the principles described herein;

FIG. 2 is a perspective view of the drill bit of FIG. 1;

FIG. 3 is a face or bottom end view of the drill bit of FIG. 2;

FIG. 4 is a partial cross-sectional view of the bit shown in FIG. 2 with the blades and the cutting faces of the cutter elements rotated into a single composite profile;

FIGS. 5A-5D are perspective, top, rear side, and lateral side views, respectively, of one of the cutter elements of the drill bit of FIG. 2;

FIG. 6A is an enlarged top view of an exemplary non-planar surface on the cutting face of the cutter element of FIG. 5A taken in section 6A-6A of FIG. 5B and illustrating an embodiment of a surface finish for reducing friction and drag;

FIG. 6B is a cross-sectional end view of the surface finish of FIG. 6A taken in section 6B-6B of FIG. 6A;

FIG. 6C is a perspective view of the surface finish of FIG. 6A;

FIGS. 7A-7D are perspective, top, front side, and lateral side views, respectively, of an embodiment of a cutter element in accordance with the principles described herein.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Any reference to up or down in the description and the claims will be made for purposes of clarity, with “up”, “upper”, “upwardly” or “upstream” meaning toward the surface of the borehole and with “down”, “lower”, “downwardly” or “downstream” meaning toward the terminal end of the borehole, regardless of the borehole orientation.

As previously described, the length of time it takes to drill to the desired depth and location impacts the cost of drilling operations. The geometry and shape of the cutting faces of the cutter elements impact bit durability and rate of penetration (ROP), and thus, are important to the success of a particular bit design. Friction arising during drilling between the cutting faces and the formation being drilled, and related drag, can reduce bit durability and ROP. To reduce friction between the cutting faces and the formation during drilling, the planar cutting faces of many conventional cutter elements are polished. However, current trends in cutter element designs include cutting faces with one or more non-planar surfaces that may be particularly difficult and time consuming to polish. Accordingly, embodiments described herein are directed to cutter elements for fixed cutter drill bits with cutting faces having non-planar surfaces with surface finishes that offer the potential to reduce friction and drag between the cutting face and the formation being cut.

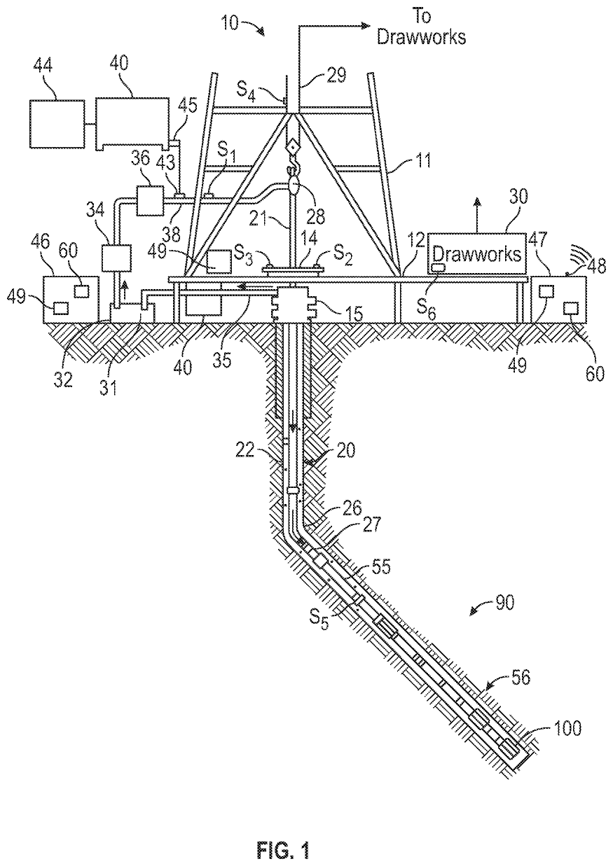

Referring now to FIG. 1, a schematic view of an embodiment of a drilling system 10 in accordance with the principles described herein is shown. Drilling system 10 includes a derrick 11 having a floor 12 supporting a rotary table 14 and a drilling assembly 90 for drilling a borehole 26 from derrick 11. Rotary table 14 is rotated by a prime mover such as an electric motor (not shown) at a desired rotational speed and controlled by a motor controller (not shown). In other embodiments, the rotary table (e.g., rotary table 14) may be augmented or replaced by a top drive suspended in the derrick (e.g., derrick 11) and connected to the drillstring (e.g., drillstring 20).

Drilling assembly 90 includes a drillstring 20 and a drill bit 100 coupled to the lower end of drillstring 20. Drillstring 20 is made of a plurality of pipe joints 22 connected end-to-end, and extends downward from the rotary table 14 through a pressure control device 15, such as a blowout preventer (BOP), into the borehole 26. The pressure control device 15 is commonly hydraulically powered and may contain sensors for detecting certain operating parameters and controlling the actuation of the pressure control device 15. Drill bit 100 is rotated with weight-on-bit (WOB) applied to drill the borehole 26 through the earthen formation. Drillstring 20 is coupled to a drawworks 30 via a kelly joint 21, swivel 28, and line 29 through a pulley. During drilling operations, drawworks 30 is operated to control the WOB, which impacts the rate-of-penetration of drill bit 100 through the formation. In this embodiment, drill bit 100 can be rotated from the surface by drillstring 20 via rotary table 14 and/or a top drive, rotated by a downhole mud motor 55 disposed along drillstring 20 proximal bit 100, or combinations thereof (e.g., rotated by both rotary table 14 via drillstring 20 and mud motor 55, rotated by a top drive and the mud motor 55, etc.). For example, rotation via mud motor 55 may be employed to supplement the rotational power of rotary table 14, if required, and/or to effect changes in the drilling process. In either case, the rate-of-penetration (ROP) of the drill bit 100 into the borehole 26 for a given formation and a drilling assembly largely depends upon the WOB and the rotational speed of bit 100.

During drilling operations a suitable drilling fluid 31 is pumped under pressure from a mud tank 32 through the drillstring 20 by a mud pump 34. Drilling fluid 31 passes from the mud pump 34 into the drillstring 20 via a desurger 36, fluid line 38, and the kelly joint 21. The drilling fluid 31 pumped down drillstring 20 flows through mud motor 55 and is discharged at the borehole bottom through nozzles in face of drill bit 100, circulates to the surface through an annular space 27 radially positioned between drillstring 20 and the sidewall of borehole 26, and then returns to mud tank 32 via a solids control system 40 and a return line 35. Solids control system 40 may include any suitable solids control equipment known in the art including, without limitation, shale shakers, centrifuges, and automated chemical additive systems. Solids control system 40 may include sensors and automated controls for monitoring and controlling, respectively, various operating parameters such as centrifuge rpm. It should be appreciated that much of the surface equipment for handling the drilling fluid is application specific and may vary on a case-by-case basis.

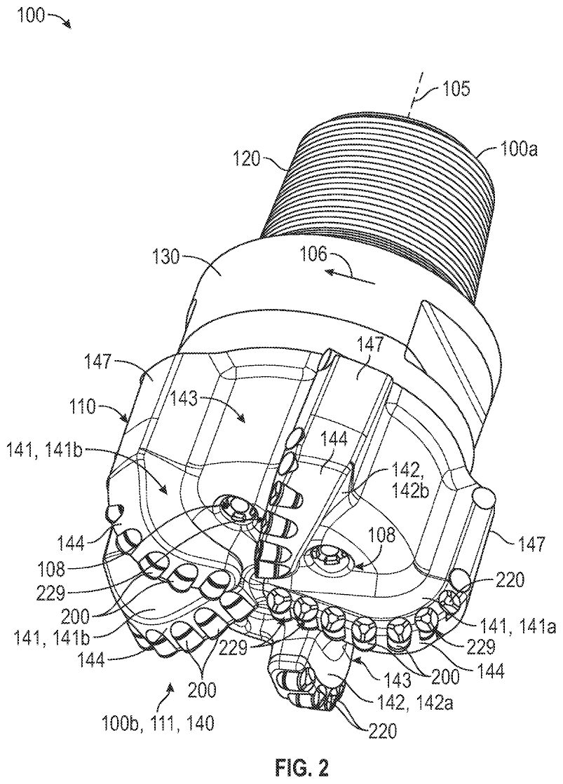

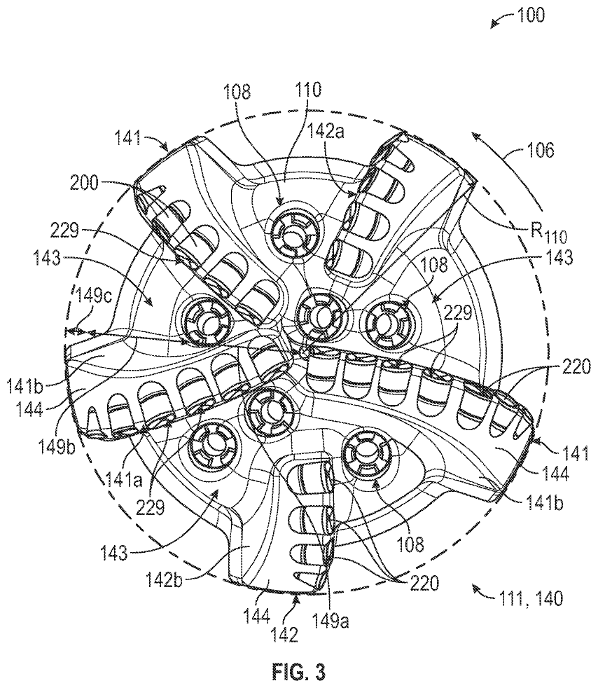

Referring now to FIGS. 2 and 3, drill bit 100 is a fixed cutter bit, sometimes referred to as a drag bit, and is designed for drilling through formations of rock to form a borehole. Bit 100 has a central or longitudinal axis 105, a first or uphole end 100a, and a second or downhole end 100b. Bit 100 rotates about axis 105 in the cutting direction represented by arrow 106. In addition, bit 100 includes a bit body 110 extending axially from downhole end 100b, a threaded connection or pin 120 extending axially from uphole end 100a, and a shank 130 extending axially between pin 120 and body 110. Pin 120 couples bit 100 to drillstring 20, which is employed to rotate the bit 100 to drill the borehole 26. Bit body 110, shank 130, and pin 120 are coaxially aligned with axis 105, and thus, each has a central axis coincident with axis 105.

The portion of bit body 110 that faces the formation at downhole end 100b includes a bit face 111 provided with a cutting structure 140. Cutting structure 140 includes a plurality of blades 141, 142, which extend from bit face 111. In this embodiment, cutting structure 140 includes three angularly spaced-apart primary blades 141, and three angularly spaced apart secondary blades 142. Further, in this embodiment, the plurality of blades (e.g., primary blades 141, and secondary blades 142) are uniformly angularly spaced on bit face 111 about bit axis 105. In this embodiment, bit 100 includes five total blades 141, 142 three primary blades 141 and two secondary blades 142. The five blades 141, 142 are uniformly angularly spaced about 72° apart. In other embodiments, the blades (e.g., blades 141, 142 may be non-uniformly circumferentially spaced about bit face 111). Although bit 100 is shown as having three primary blades 141 and two secondary blades 142, in other embodiments, the bit (e.g., bit 100) may comprise any suitable number of primary and secondary blades such as two primary blades and four secondary blades or three primary blades and three secondary blades.

In this embodiment, primary blades 141 and secondary blades 142 are integrally formed as part of, and extend from, bit body 110 and bit face 111. Primary blades 141 and secondary blades 142 extend generally radially along bit face 111 and then axially along a portion of the periphery of bit 100. In particular, primary blades 141 extend radially from proximal central axis 105 toward the periphery of bit body 110. Primary blades 141 and secondary blades 142 are separated by drilling fluid flow courses 143. Each blade 141, 142 has a leading edge or side 141a, 142a, respectively, and a trailing edge or side 141b, 142b, respectively, relative to the direction of rotation 106 of bit 100.

Referring still to FIGS. 2 and 3, each blade 141, 142 includes a cutter support surface 144 for mounting a plurality of cutter elements 200. In particular, cutter elements 200 are arranged adjacent one another in a radially extending row proximal the leading edge of each primary blade 141 and each secondary blade 142. In this embodiment, each cutter element 200 has substantially the same size and geometry, which will be described in more detail below.

As will also be described in more detail below, each cutter element 200 has a cutting face 220. In the embodiments described herein, each cutter element 200 is mounted such that its cutting face 220 is generally forward-facing. As used herein, “forward-facing” is used to describe the orientation of a surface that is substantially perpendicular to, or at an acute angle relative to, the cutting direction of the bit (e.g., cutting direction 106 of bit 100).

Referring still to FIGS. 2 and 3, bit body 110 further includes gage pads 147 of substantially equal axial length measured generally parallel to bit axis 105. Gage pads 147 are circumferentially-spaced about the radially outer surface of bit body 110. Specifically, one gage pad 147 intersects and extends from each blade 141, 142. In this embodiment, gage pads 147 are integrally formed as part of the bit body 110. In general, gage pads 147 can help maintain the size of the borehole by a rubbing action when cutter elements 200 wear slightly under gage. Gage pads 147 also help stabilize bit 100 against vibration.

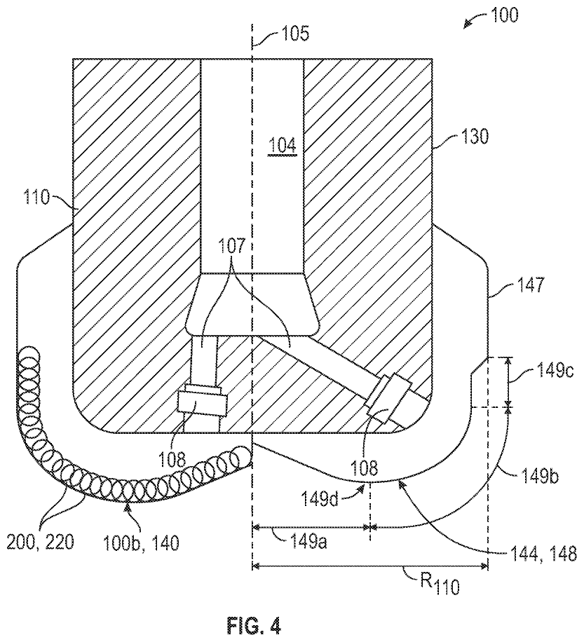

Referring now to FIG. 4, an exemplary profile of bit body 110 is shown as it would appear with blades 141, 142 and cutting faces 220 rotated into a single rotated profile. In rotated profile view, blades 141, 142 of bit body 110 form a combined or composite blade profile 148 generally defined by cutter support surfaces 144 of blades 141, 142. In this embodiment, the profiles of surfaces 144 of blades 141, 142 are generally coincident with each other, thereby forming a single composite blade profile 148.

Composite blade profile 148 and bit face 111 may generally be divided into three regions conventionally labeled cone region 149a, shoulder region 149b, and gage region 149c. Cone region 149a defines the radially innermost region of bit body 110 and composite blade profile 148, and extends from bit axis 105 to shoulder region 149b. In this embodiment, cone region 149a is generally concave. Adjacent cone region 149a is the generally convex shoulder region 149b. The transition between cone region 149a and shoulder region 149b, typically referred to as the nose 149d, occurs at the axially lowermost/outermost portion of composite blade profile 148 where a tangent line to the blade profile 148 has a slope of zero. Moving radially outward, adjacent shoulder region 149b is the gage region 149c which extends substantially parallel to bit axis 105 at the outer radial periphery of composite blade profile 148. As shown in composite blade profile 148, gage pads 147 define the gage region 149c and the outer radius R₁₁₀ of bit body 110. Outer radius R₁₁₀ extends to and therefore defines the full gage diameter of bit body 110. As used herein, the term “full gage diameter” refers to elements or surfaces extending to the full, nominal gage of the bit diameter.

Referring now to FIGS. 3 and 4, moving radially outward from bit axis 105, bit face 111 includes cone region 149a, shoulder region 149b, and gage region 149c as previously described. Primary blades 141 extend radially along bit face 111 from within cone region 149a proximal bit axis 105 toward gage region 149c and outer radius R₁₁₀. Secondary blades 142 extend radially along bit face 111 from proximal nose 149d toward gage region 149c and outer radius R₁₁₀. Thus, in this embodiment, each primary blade 141 and each secondary blade 142 extends substantially to gage region 149c and outer radius R₁₁₀. In this embodiment, secondary blades 142 do not extend into cone region 149a, and thus, secondary blades 142 occupy no space on bit face 111 within cone region 149a. Although a specific embodiment of bit 100 and corresponding bit body 110 has been shown in described, one skilled in the art will appreciate that numerous variations in the size, orientation, and locations of the blades (e.g., primary blades 141, secondary blades, 142, etc.), and cutter elements (e.g., cutter elements 200) are possible.

As best shown in FIG. 4, bit 100 includes an internal plenum 104 extending axially from uphole end 100a through pin 120 and shank 130 into bit body 110. Plenum 104 permits drilling fluid to flow from the drillstring 20 into bit 100. Body 110 is also provided with a plurality of flow passages 107 extending from plenum 104 to downhole end 100b. A nozzle 108 is seated in the lower end of each flow passage 107. Together, flow passages 107 and nozzles 108 distribute drilling fluid around cutting structure 140 to flush away formation cuttings and to remove heat from cutting structure 140, and more particularly cutter elements 200, during drilling.

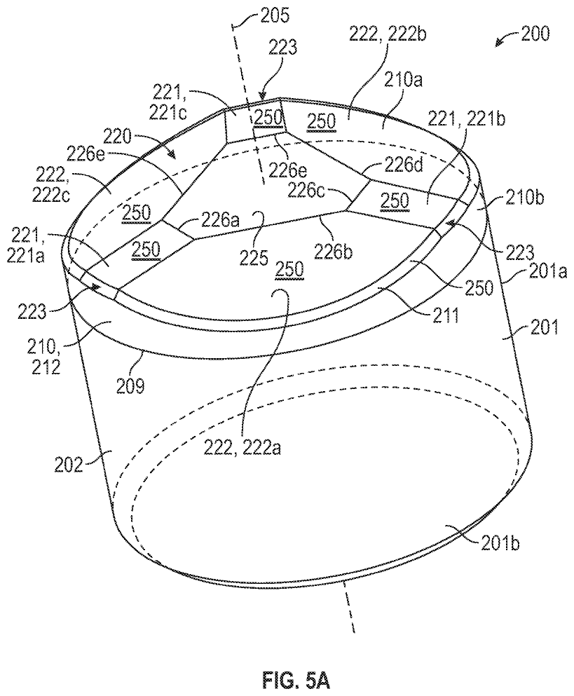

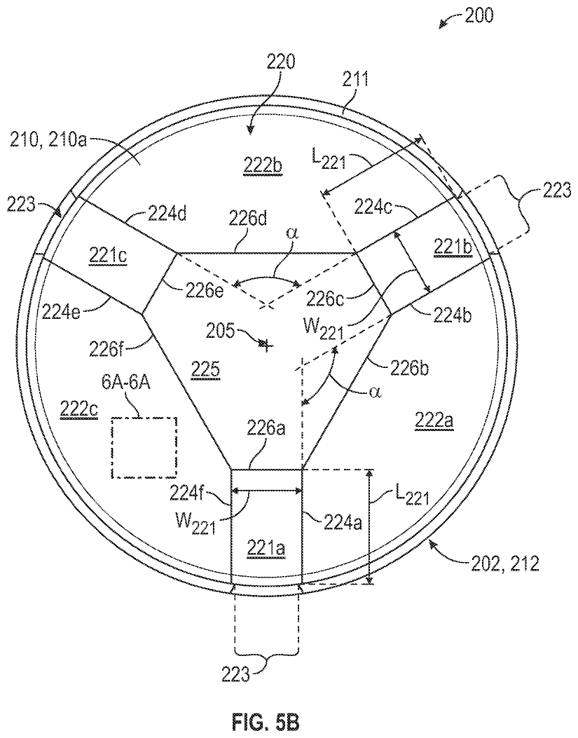

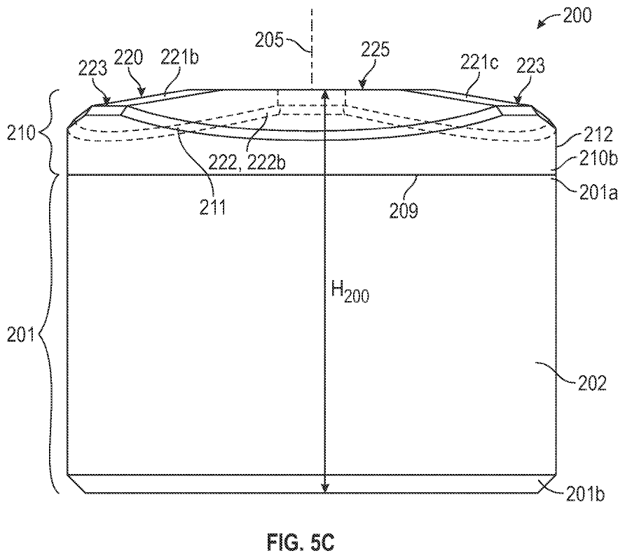

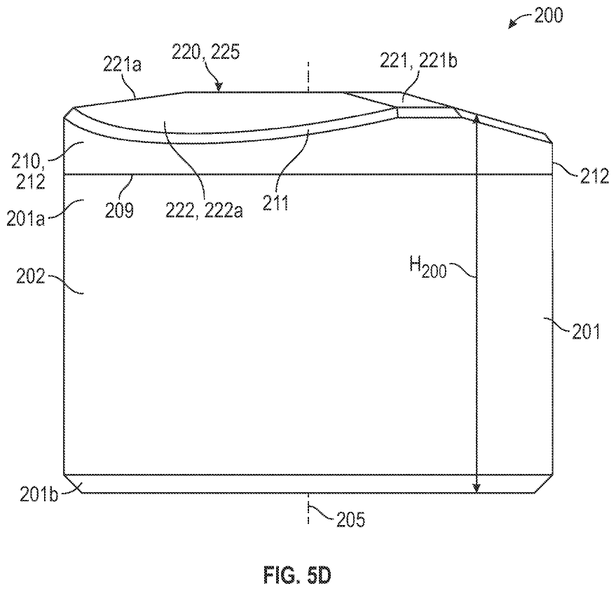

Referring now to FIGS. 5A-5D, one cutter element 200 is shown. Although only one cutter element 200 is shown in FIGS. 5A-5D, it is to be understood that all cutter elements 200 of bit 100 are the same. In general, bit 100 may include any number of cutter elements 200, and further, cutter elements 200 can be used in connection with different cutter elements (e.g., cutter elements having geometries different than cutter element 200) on the same bit (e.g., bit 100).

In this embodiment, cutter element 200 includes a base or substrate 201 and a cutting disc or layer 210 bonded to the substrate 201. Cutting layer 210 and substrate 201 meet at a reference plane of intersection 209 that defines the location at which substrate 201 and cutting layer 210 are fixably attached. In this embodiment, substrate 201 is made of tungsten carbide and cutting layer 210 is made of an ultrahard material such as polycrystalline diamond (PCD) or other superabrasive material. Part and/or all of the diamond in cutting layer 210 may be leached, finished, polished, and/or otherwise treated to enhance durability, efficiency and/or effectiveness. While cutting layer 210 is shown as a single layer of material mounted to substrate 201, in general, the cutting layer (e.g., layer 210) may be formed of one or more layers of one or more materials. In addition, although substrate 201 is shown as a single, homogenous material, in general, the substrate (e.g., substrate 201) may be formed of one or more layers of one or more materials.

Substrate 201 has a central axis 205, a first end 201a bonded to cutting layer 210 at plane of intersection 209, a second end 201b opposite end 201a and distal cutting layer 210, and a radially outer surface 202 extending axially between ends 201a, 201b. In this embodiment, substrate 201 is generally cylindrical, and thus, outer surface 202 is generally cylindrical. As best shown in FIGS. 5A, 5C, and 5D, end 201b comprises an annular chamfer or bevel extending about the entire circumference of substrate 201 in this embodiment.

Referring still to FIGS. 5A-5D, cutting layer 210 has a first end 210a distal substrate 201, a second end 210b bonded to end 201a of substrate 201 at plane of intersection 209, and a radially outer surface 212 extending axially between ends 210a, 210b. In this embodiment, cutting layer 210 is generally disc-shaped, and thus, outer surface 212 is generally cylindrical. In addition, outer surfaces 202, 212 are coextensive and contiguous such that there is a generally smooth transition moving axially between outer surfaces 202, 212.

The outer surface of cutting layer 210 at first end 210a defines the cutting face 220 of cutter element 200 and is designed and shaped to engage and shear the formation during drilling operations. In this embodiment, a chamfer or bevel 211 is provided at the intersection of cutting face 220 and outer surface 212 about the entire outer periphery of cutting face 220. Chamfer 211 is non-planar, and thus, chamfer 211 may also be referred to as a “non-planar” surface. More specifically, in this embodiment, chamfer 211 is generally frustoconical and convex or bowed outwardly. As will be described in more detail below, in embodiments described herein, non-planar bevel 211 comprises a surface finish 250 to reduce friction and drag between chamfer 211 and the formation being cut with cutter element 200.

As best shown in the top view of cutter element 200 in FIG. 5B (looking at cutting face 220 as viewed parallel to central axis 205), in this embodiment, cutting face 220 is generally symmetric about central axis 205. In particular, cutting face 220 is generally convex or bowed outward in the side view (front, rear, and lateral side views) as shown in FIGS. 5C and 5D for example. In addition, in this embodiment, cutting face 220 is defined by a plurality of discrete regions or surfaces that intersect at linear boundaries or edges. More specifically, as best shown in FIGS. 5A and 5B, cutting face 220 includes a central region or surface 225, a plurality of uniformly circumferentially-spaced a cutting regions, ridges, or surfaces 221 extending radially from central region 225 to outer surface 212 and chamfer 211, and a plurality of uniformly circumferentially-spaced relief regions or surfaces 222 extending from central region 225 and cutting regions 221 to outer surface 212 and chamfer 211. Regions 221, 222 are circumferentially disposed about axis 205 and central region 225. In addition, regions 221, 222 are arranged in a circumferentially alternating manner such that regions 221, 222 are positioned circumferentially adjacent each other with each region 221 circumferentially disposed between a pair of circumferentially-adjacent regions 222, and each region 222 circumferentially disposed between a pair of circumferentially-adjacent regions 221. Consequently, the number of cutting regions 221 and the number of relief regions 222 is the same. In this embodiment, cutting face 220 includes three cutting regions 221 and three relief regions 222. However, in other embodiments, more than three cutting regions (e.g., regions 221) and more than three relief regions (e.g., regions 222) may be provided it being understood that the number of cutting regions and relief regions is the same (e.g., five cutting regions and five relief regions, six cutting regions and six relief regions, etc.). As cutting face 220 includes three uniformly circumferentially spaced cutting regions 221 and three uniformly circumferentially-spaced relief regions 222, in this embodiment, the radial centerlines of cutting regions 221 are angularly spaced 120° apart about axis 205 and the radial centerlines of relief regions 222 are angularly spaced 120° apart about axis 205. In this embodiment, each cutting region 221 has the same geometry and each relief region 222 has the same geometry. Due to the uniform spacing of regions 221 and regions 222, and uniformity of geometry of regions 221 and regions 222, the radial centerline of each region 221, 222 is disposed in a plane containing central axis 205.

For purposes of clarity and further explanation, the three cutting regions 221 of cutting face 220 are labeled 221a, 221b, 221c and the three relief regions 222 of cutting face 220 are labeled 222a, 222b, 222c. As previously described, regions 221, 222 are arranged in an circumferentially alternating manner such that regions 221, 222 are positioned circumferentially adjacent each other with each region 221 circumferentially disposed between a pair of circumferentially-adjacent regions 222, and each region 222 circumferentially disposed between a pair of circumferentially-adjacent regions 221. More specifically, relief region 222a extends circumferentially from cutting region 221a to cutting region 221b, relief region 222b extends circumferentially from cutting region 221b to cutting region 221c, and relief region 222c extends circumferentially from cutting region 221c to cutting region 221a. Thus, each cutting region 221a, 221b, 221c extends circumferentially between a pair of circumferentially adjacent regions 222a, 222b, 222c, and each relief region 222a, 222b, 222c extends circumferentially between a pair of circumferentially adjacent cutting regions 221a, 221b, 221c.

As best shown in FIG. 5B, a linear boundary or edge is provided at the intersection of each circumferentially adjacent region 221, 222, and a linear boundary or edge is provided at the intersection of central region 225 and each region 221, 222. In particular, regions 221a, 222a intersect at a linear edge 224a, regions 222a, 221b intersect at a linear edge 224b, regions 221b, 222b intersect at a linear edge 224c, regions 222b, 221c intersect at a linear edge 224d, regions 221c, 222c intersect at a linear edge 224e, and regions 222c, 221a intersect at a linear edge 224f. Thus, region 221a may be described as extending circumferentially between edges 224a, 224f, region 222a may be described as extending circumferentially between edges 224a, 224b, region 221b may be described as extending circumferentially between edges 224b, 224c, region 222b may be described as extending circumferentially between edges 224c, 224d, region 221c may be described as extending circumferentially between edges 224d, and 224e, region 222c may be described as extending circumferentially between edges 224e, 224f. In addition, regions 225, 221a intersect at a linear edge 226a, regions 225, 222a intersect at a linear edge 226b, regions 225, 221b intersect at a linear edge 226c, regions 225, 222b intersect at a linear edge 226d, regions 225, 221c intersect at a linear edge 226e, and regions 225, 222c intersect at a linear edge 226f. Linear edges 226a, 226b, 226c, 226d, 226e, 226f are connected end-to-end to form the closed polygon that defines central region 225 as will be described in more detail below.

As previously described, in this embodiment, cutting regions 221a, 221b, 221c intersect central region 225 at defined linear edges 226a, 226c, 226e, relief regions 222a, 222b, 222c intersect central region 225 at defined linear edges 226b, 226d, 226f, and cutting regions 221a, 221b, 221c intersect relief regions 222a, 222b, 222c at defined linear edges 224a, 224b, 224c, 224d, 224e, 224f. However, in other embodiments, the cutting regions (e.g., cutting regions 221a, 221b, 221c) may intersect the central region (e.g., central region 225) at smoothly curved, continuously contoured surfaces, the relief regions (e.g., relief regions 222a, 222b, 222c) may intersect the central region at smoothly curved, continuously contoured surfaces, the cutting regions may intersect the relief regions at smoothly curved, continuously contoured surfaces, or combinations thereof.

Each linear edge 224a, 224b, 224c, 224d, 224e, 224f extends generally radially from central region 225 to outer surface 212 and chamfer 211. In this embodiment, linear edges 224a, 224f are parallel to each other moving radially along cutting region 221a from central region 225 to outer surface 212 and chamfer 211, linear edges 224b, 224c are parallel to each other moving radially along cutting region 221b from central region 225 to outer surface 212 and chamfer 211, and linear edges 224d, 224e are parallel to each other moving radially along cutting region 221c from central region 225 to outer surface 212 and chamfer 211. In contrast, linear edges 224a, 224b defining the circumferential ends of relief region 222a slope or taper away from each other moving radially along relief region 222a from central region 225 to outer surface 212 and chamfer 211, linear edges 224c, 224d defining the circumferential ends of relief region 222b slope or taper away from each other moving radially along relief region 222b from central region 225 to outer surface 212 and chamfer 211, and linear edges 224e, 224f defining the circumferential ends of relief region 222c slope or taper away from each other moving radially along relief region 222c from central region 225 to outer surface 212 and chamfer 211. Consequently, each pair of linear edges 224a, 224b, 224c, 224d, 224e, 224f defining the circumferential ends of relief regions 222a, 222b, 222c are oriented at an angle α relative to each other in top view. The angle α between linear edges 224a, 224b, the angle α between linear edges 224c, 224d, and the angle α between linear edges 224e, 224f are each preferably between 45° and 75°, and more preferably between 55° and 65°. In this embodiment, each angle α is 60°. It should be appreciated that as the number of relief regions (e.g., relief regions 222a, 222b, 222c) increase, the angle α associated with each relief region may decrease; and as the number of relief regions decreases, the angle α associated with each relief region may increase.

Referring still to FIG. 5B, each cutting region 221a, 221b, 221c has a width W₂₂₁ measured perpendicularly from one edge 224f, 224b, 224d of the region 221a, 221b, 221c, respectively, to the other edge 224f, 224c, 224e of the region 221a, 221b, 221c, respectively, in top view. Since edges 224f, 224a of cutting region 221a are parallel, edges 224b, 224c of cutting region 221b are parallel, and edges 224d, 224e of cutting region 221c are parallel, the width W₂₂₁ of each cutting region 221a, 221b, 221c is uniform or constant moving radially along the region 221a, 221b, 221c, respectively, from central region 225 to outer surface 212 and chamfer 211. In this embodiment, the circumferential width of each relief region 222a, 222b, 222c is greater than the width W₂₂₁ of each cutting region 221a, 221b, 221c, and thus, the length of each edge 226b, 226d, 226f is greater than the length of each edge 226a, 226c, 226e. In embodiments described herein, the width W₂₂₁ of each cutting region 221a, 221b, 221c is preferably ranges from 1.0 mm to 5.0 mm, and more preferably ranges from 1.0 mm to 2.0 mm; and the ratio of the width W₂₂₁ of each cutting region 221a, 221b, 221c to the diameter of cutter element 200 preferably ranges from 0.05 to 0.50, and more preferably ranges from 0.10 to 0.17. In addition, each cutting region 221a, 221b, 221c has a length L₂₂₁ measured radially and perpendicular to edge 226a, 226c, 226e, respectively, from the central region 225 and the corresponding edge 226a, 226c, 226e to outer surface 212 and chamfer 211. In embodiments described herein, the ratio of the length L₂₂₁ of each cutting region 221a, 221b, 221c to the diameter of the cutter element 200 preferably ranges from 0.0 to 0.5, and more preferably ranges from 0.125 to 0.325. In this embodiment, the ratio of the width W₂₂₁ of each cutting region 221a, 221b, 221c to the diameter of cutter element 200 is 0.14, and the ratio of the length L₂₂₁ of each cutting region 221a, 221b, 221c to the diameter of the cutter element 200 is 0.25.

In this embodiment, the width W₂₂₁ of each cutting region 221a, 221b, 221c is the same and the length L₂₂₁ of each cutting region 221a, 221b, 221c is the same. However, in other embodiments, the width of any two or more cutting regions (e.g., width W₂₂₁ of any two or more cutting regions 221a, 221b, 221c) may be the same or different, the width of any one or more cutting regions may vary moving radially along the cutting region from the central region (e.g., central region 225) to the outer surface (e.g., outer surface 212), the length of any two or more cutting regions (e.g., the width L₂₂₁ of any two or more cutting regions 221a, 221b, 221c) may be the same or different, or combinations thereof.

Referring now to FIGS. 5A and 5B, central region 225 is radially centered on cutting face 220 and centered relative to axis 205. In particular, axis 205 intersects the geometric center of central region 225. In this embodiment, central surface or region 225 is planar, and thus, may also be referred to as a “planar” surface. In addition, in this embodiment, central region 225 is oriented perpendicular to axis 205 and has a polygonal shape defined by the plurality of linear edges 226a, 226b, 226c, 226d, 226e, 226f at the intersection of central region 225 and each region 221a, 221b, 221c, 222a, 222b, 222c, respectively. In this embodiment, the three cutting regions 221a, 221b, 221c and the three relief regions 222a, 222b, 222c define six sides of central region 225 at edges 226a, 226b, 226c, 226d, 226e, 226f, and thus, central region 225 has a hexagonal shape. In general, the number of sides of the polygonal central regions of embodiments described herein (e.g., central region 225) is equal to the number of cutting regions (e.g., cutting regions 221a, 221b, 221c) plus the number of relief regions (e.g., relief regions 222a, 222b, 222c). Although edges 226a, 226b, 226c, 226d, 226e, 226f defining central region 225 are linear in this embodiment of cutter element 200, in other embodiments, the edges defining the central region (e.g., edges 226a, 226b, 226c, 226d, 226e, 226f defining central region 225 are linear in this embodiment of cutter element 200) are concave and bow inwardly toward the central axis of the cutter element (e.g., axis 205) .

Referring again to FIGS. 5A-5D, each cutting region 221a, 221b, 221c extends radially from central region 225 to outer surface 212 and chamfer 211. In this embodiment, each cutting region 221a, 221b, 221c is non-planar, and thus, may also be referred to as a “non-planar” surface. More specifically, in this embodiment, each cutting region 221a, 221b, 221c is convex or bowed outwardly. However, in other embodiments, one or more of the cutting regions (e.g., cutting regions 221a, 221b, 221c) may be concave or bowed inwardly. In addition, in this embodiment, each cutting region 221a, 221b, 221c generally slopes axially downward toward substrate 201 moving radially outward from central region 225 to outer surface 212 and chamfer 211. As will be described in more detail below, the pair of relief regions 222 disposed on each lateral side of each cutting region 221 generally slope axially downward moving circumferentially away from the cutting region 222. Consequently, each cutting region 221 may be described as a raised “ridge” or a cutting “ridge” disposed between a corresponding pair of circumferentially adjacent relief regions 222 and extending from central region 225 to outer surface 212 and chamfer 211.

Although cutting regions 221a, 221b, 221c are non-planar and convex in this embodiment, in other embodiments, one or more of the cutting regions (e.g., cutting regions 221a, 221b, 221c) may be planar or concave (i.e., bowed inwardly). As will be described in more detail below, in embodiments described herein, each non-planar cutting region 221a, 221b, 221c comprises a surface finish 250 to reduce friction and drag between the cutting region 221a, 221b, 221c and the formation being cut with cutter element 200.

As will be described in more detail below, cutter elements 200 are mounted to cutter supporting surfaces 144 of blades 141, 142 with the radially outer end (relative to axis 205) of one of the cutting regions 221a, 221b, 221c of each cutter element 200 positioned to engage and shear the formation. Accordingly, the edge at the radially outer end of each cutting region 221a, 221b, 221c distal central region 225 (e.g., at the intersection of each cutting region 221a, 221b, 221c and chamfer 211) defines a cutting edge 223 of cutter element 200.

Referring again to FIGS. 5A-5D, each relief region 222a, 222b, 222c extends from central region 225 and the pair of circumferentially adjacent cutting regions 221a, 221b, 221c to outer surface 212 and chamfer 211. In this embodiment, each relief region 222a, 222b, 222c is a non-planar, and thus, may also be referred to as a “non-planar planar” surface. More specifically, in this embodiment, each relief region 222a, 222b, 222c is convex or bowed outwardly. However, in other embodiments, one or more of the relief regions (e.g., relief region 222a, 222b, 222c) may be concave or bowed inwardly. In addition, in this embodiment, each relief region 222a, 222b, 222c generally slopes axially downward toward substrate 201 moving radially outward from central region 225 to outer surface 212 and chamfer 211.

Although relief regions 222a, 222b, 222c are non-planar and convex in this embodiment, in other embodiments, one or more of the relief regions (e.g., relief regions 222a, 222b, 222c) may be planar or concave (i.e., bowed inwardly). As will be described in more detail below, in embodiments described herein, each non-planar relief region 222a, 222b, 222c comprises a surface finish 250 to reduce friction and drag between the relief region 222a, 222b, 222c and the formation being cut with cutter element 200.

Referring to FIGS. 5A-5D, as previously described, cutting regions 221 slope axially downward toward substrate 201 moving from central region 225 to outer surface 212 and chamfer 211, and relief regions 222 slope axially downward toward substrate 201 moving from central region 225 to outer surface 212 and chamfer 211. As a result, central regions 225 defines a peak along cutting face 220. More specifically, as best shown in FIGS. 5C and 5D, cutter element 200 has a height H₂₀₀ measured axially (relative to axis 205) from end 201b to cutting face 220 at end 210a in side view. The height H₂₀₀ of cutter element is maximum and constant along central region 225, and then decreases moving from along cutting regions 221 and relief regions 222 from central region 225 to outer surface 212 and chamfer 211.

Referring again to FIGS. 2 and 3, cutter elements 200 are mounted in bit body 110 such that cutting faces 220 are exposed to the formation material, and further, such that cutting faces 220 are oriented so that cutting edges 223, cutting regions 221, and relief regions 222 are positioned to perform their distinct functional roles in shearing, excavating, and removing rock from beneath the drill bit 100 during rotary drilling operations. More specifically, each cutter element 200 is mounted to a corresponding blade 141, 142 with substrate 201 received and secured in a pocket formed in the cutter support surface 144 of the blade 141, 142 to which it is fixed by brazing or other suitable means. In addition, each cutter element 200 is oriented with axis 205 oriented generally parallel or tangent to cutting direction 106 and such that the corresponding cutting face 220 is exposed and leads the cutter element 200 relative to cutting direction 106 of bit 100. As previously described, cutting faces 220 are forward-facing. In addition, each cutter element 200 is oriented with one cutting edge 223 distal the corresponding cutter support surface 144 to define an extension height of the corresponding cutter element 200. In general, the extension height of a cutter element (e.g., cutter element 200) is the distance from the cutter support surface of the blade to which the cutter element is mounted to the outermost point or portion of the cutter element as measured perpendicular to the cutter supporting surface. The extension heights of cutter elements 200 can be selected to so as to ensure that cutting edges 223 of cutter elements 200 achieve the desired depth of cut, or at least be in contact with the rock during drilling.

During drilling operations, each cutting face 220 engages, penetrates, and shears the formation as the bit 100 is rotated in the cutting direction 106 and is advanced through the formation. Due to the orientation of cutter elements 200, the cutting edges 223 defining the extension heights of cutter elements 200 function as the primary cutting edges as cutter elements 200 engage the formation. The sheared formation material slides along the corresponding cutting regions 221 and the pairs of circumferentially adjacent relief regions 222 as cutting faces 220 pass through the formation. Thus, as each cutting face 220 advances through the formation, it cuts a kerf in the formation generally defined by the cutting profile of the cutting face 220. The geometry of cutting face 220 is particularly designed to offer the potential to improving cutting efficiency and cleaning efficiency to increase rate of penetration (ROP) and durability of bit 100. In particular, the downward slope of cutting regions 221 toward substrate 201 moving from central region 225 to outer surface 212 increases relief relative to the corresponding cutting edge 223, which allows drilling fluid to be directed toward the cutting edge 223 and formation cuttings to efficiently slide along cutting face 220. The downward slope of the pair of circumferentially adjacent relief regions 222 toward substrate 201 moving laterally from the cutting edge 223 allows cutting face 220 to draw the extrudates of formation material. In addition, surface finishes 250 on chamfer 211, cutting regions 221a, 221b, 221c, and relief regions 222a, 222b, 222c described in more detail below offer the potential to reduce friction and drag between such surfaces and the formation being cut. Although each non-planar surface on cutting face 220 comprises surface finish 250 in this embodiment, in other embodiments, any one or more of the non-planar surface(s) on the cutting face (e.g., cutting face 220) may include the surface finish (e.g., surface finish 250).

As previously described, embodiments of cutter elements 200 include a plurality of circumferentially-spaced cutting edges 223. In the embodiment of cutter element 200 shown in FIGS. 5A-5D, three uniformly circumferentially-spaced cutting edges 223 are provided. Thus, each cutter element 200 can be oriented such that one of the cutting edges 223 of each cutter element 200 is used first to engage, penetrate, and shear the formation, and then when those cutting edges 223 are sufficiently worn (e.g., the cutting efficiency and rate of penetration of the bit are sufficiently low), cutter elements 200 can be removed from the bit body 110, and then re-mounted to bit body 110 with another one of the cutting edges 223 of each cutter element 200 positioned to engage, penetrate and shear the formation. Since this embodiment of cutter element 200 includes three cutting edges 223, cutter elements 200 can be removed, remounted, and reused twice. The ability to reuse cutter elements 200 after one cutting edge 223 is sufficiently worn offers the potential to significantly increase the operating lifetime of cutter elements 200 as compared to other cutter elements that include only one primary cutting edge.

In the embodiment of cutter element 200 previously described and shown in FIGS. 5A-5D, cutting regions 221 are relatively wide (e.g., the ratio of the width W₂₂₁ of each cutting region 221a, 221b, 221c to the diameter of cutter element 200 is larger than 0.10, and edges 226a, 226b, 226c, 226d, 226e, 226f between regions 221, 222 and central region 225 are linear. However, in other embodiments, the cutting ridges (e.g., cutting ridges 221) may be wider, the boundaries between the cutting ridges and the central region (e.g., edges 226a, 226c, 226e) may be curved, the boundaries between the relief regions (e. g, relief regions 222) and the central regions (e.g., edges 226b, 226d, 226f) may be curved, or combinations thereof.

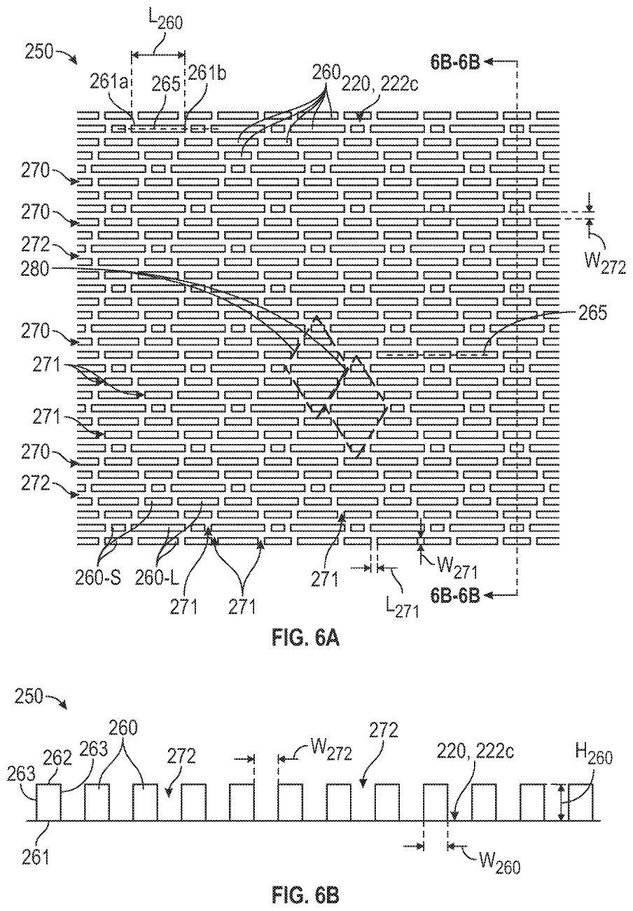

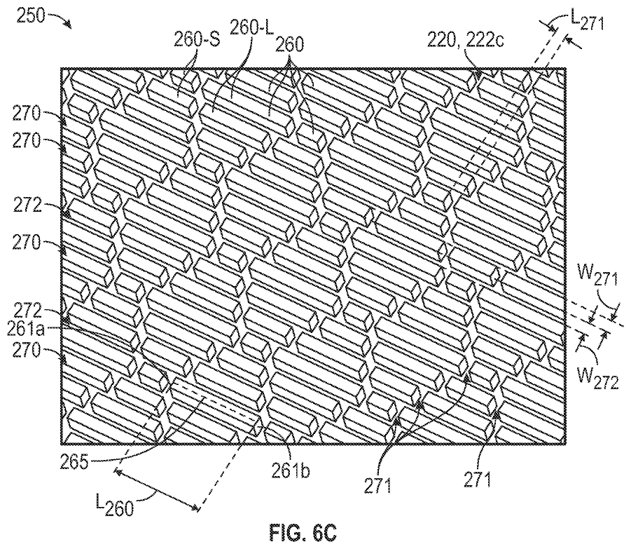

As previously described, non-planar bevel 211, non-planar cutting regions 221a, 221b, 221c, and non-planar relief regions 222a, 222b, 222c on cutting face 220 comprise surface finish 250 to reduce drag and friction between such surfaces and the formation being cut. In this embodiment, each non-planar cutting region 21a, 221b, 221c and each non-planar relief region 222a, 222b, 222c comprises the same surface finish 250 shown in FIGS. 6A-6C, which will now be described in detail.

Referring now to FIGS. 6A-6C, surface finish 250 is shown. In this embodiment, surface finish 250 includes a plurality of elongate, parallel raised ridges 260. Each ridge 260 has a central or longitudinal axis 265, a first end 261a, a second end 261b opposite the first end 261a, and a length L₂₆₀ measured axially (i.e., parallel to axis 265) from first end 261a to second end 261b.

As best shown in FIGS. 6A and 6C, ridges 260 are arranged in a plurality of laterally adjacent, laterally spaced, parallel rows 270. Each row 270 includes a plurality of axially aligned and axially spaced ridges 260. In this embodiment, two or more ridges 260 within each row 270 have different axial lengths L₂₆₀. More specifically, in this embodiment, the ridges 260 within each row 270 are arranged in an axially alternating pattern of “long” ridges 260 and “short” ridges 260 where the long ridges 260 in the row 270 have lengths L₂₆₀ that are greater than the lengths L₂₆₀ of the short ridges 260 in the same row 270. For purposes of clarity and further explanation, long ridges 260 in each row 270 may also be identified with reference numerals 260-L, and short ridges 260 in each row 270 may also be identified with reference numerals 260-S. In this embodiment, within each row 270, each long ridge 260-L has the same length L₂₆₀ and each short ridge 260-S has the same length L₂₆₀. However, in other embodiments, the longer ridges (e.g., ridges 260-L) may have different lengths (e.g., different lengths length L₂₆₀) and the shorter ridges (e.g., ridges 260-S) may have different lengths (e.g., different lengths length L₂₆₀).

Due to the axial spacing of ridges 260 in the same row 270, a recess 271 is positioned between each pair of axially adjacent ridges 260 in the same row 270. Each recess 271 has an axial length L₂₇₁ measured parallel to the longitudinal axes 265 of ridges 260 and a lateral width W₂₇₁ measured perpendicular to longitudinal axes 265 of ridges 260. In this embodiment, each recess 271 (in the same row 270 and in different rows 270) has the same length L₂₇₁. The lateral width W₂₇₁ of each recess 271 is the same as the width of the ridges 260 in the same row 270 as will be described in more detail below.

Referring again to FIGS. 6A to 6C, due to the lateral spacing of laterally adjacent rows 270, an elongate recess 272 is laterally positioned between each pair of laterally adjacent rows 270 and laterally positioned between the ridges 260 in each pair of laterally adjacent rows 270. The recesses 272 between each pair of laterally adjacent rows 270 are oriented parallel to each other, to ridges 260, and to rows 270. In embodiments described herein, each recess 272 extends linearly, parallel to longitudinal axes 265 along the entire length of the laterally adjacent rows 270. In addition, each recess 272 has a lateral width W₂₇₂ that is the same as the width of the ridges 260 in the laterally adjacent rows 270 as will be described in more detail below.

Referring now to FIG. 6B, in this embodiment, each ridge 260 has the same cross-sectional geometry and size, and more specifically, each ridge 260 has the same cross-sectional geometry and size along its entire length L₂₆₀. In this embodiment, each ridge 260 has a rectangular cross-sectional geometry including a first or fixed end 261 integral with cutting face 220, a second or free end 262 distal cutting face 220, and a pair of parallel lateral sides 263 extending from fixed end 261 to free end 262. In this embodiment, lateral sides 263 are planar and extend perpendicularly from the corresponding non-planar surface of cutting face 220, and free end 262 is defined by a planar surface extending perpendicularly between lateral sides 263.

Referring still to FIG. 6B, each ridge 260 has a width W₂₆₀ measured perpendicularly between lateral sides 263 and a height H₂₆₀ measured perpendicularly to free end and the corresponding non-planar surface from fixed end 261 to free end 262. As previously described, the lateral width W₂₇₁ each recess 271 and the lateral width W₂₇₂ of each recess 272 is the same as the width W₂₆₀ of the ridges 260. Although ridges 260 have rectangular cross-sectional geometries in this embodiment, in other embodiments, the ridges of the textured surface finish (e.g., ridges 260 of textured surface finish 250) may have other cross-sectional geometries including triangular, semi-circular, or trapezoidal, but preferably have the cross-sectional dimensions (e.g., widths W₂₆₀ and heights H₂₆₀) as described herein.

Referring now to FIGS. 6A and 6C, ridges 260 are arranged in a pattern such that no two recesses 271 in laterally adjacent rows 270 are axially aligned moving laterally from one row 270 to the laterally adjacent row 270. In other words, each recess 271 in each row 270 is axially mis-aligned and axially staggered with respect to each recess 271 in each laterally adjacent row 270. For example, movement laterally (upward or downward) in FIG. 6A through any recess 271 in any row 270 toward an adjacent row 270 will result in impacting a ridge 260 in the laterally adjacent row 270 and not passage through a recess 271 in the adjacent row 270. In this embodiment, the ridges 260 in laterally adjacent rows 270 are arranged in a plurality of diamond patterns as best shown in FIGS. 6A and 6C as identified with the dashed line 280.

In general, recesses 271, 272 and ridges 260 can be formed by any suitable means known in the art. In embodiments described herein, recesses 271, 272 and ridges 260 are formed by laser etching to the desired non-planar surface(s) to achieve the desired sizing, positioning, and geometry. As described above, a conventional approach to reducing friction between the cutting face of a cutter element and the formation being cut is to polish the cutting face. However, polishing is generally limited to planar surfaces, and is relatively difficult to do with regard to non-planar surfaces. In embodiments described herein, surface finish 250 including ridges 260 separated by recesses 271, 272 provided on one or more non-planar surfaces of cutting face 220 generally limits the surface area contacting the formation to the surface area defined by ends 262 of ridges 260, thereby offering the potential to reduce friction between such non-planar surfaces and the formation, enhance durability of the corresponding cutter element, and enhance ROP.

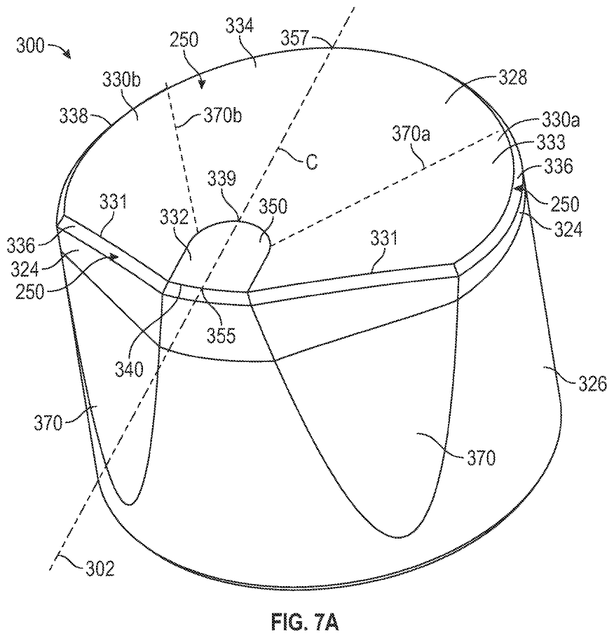

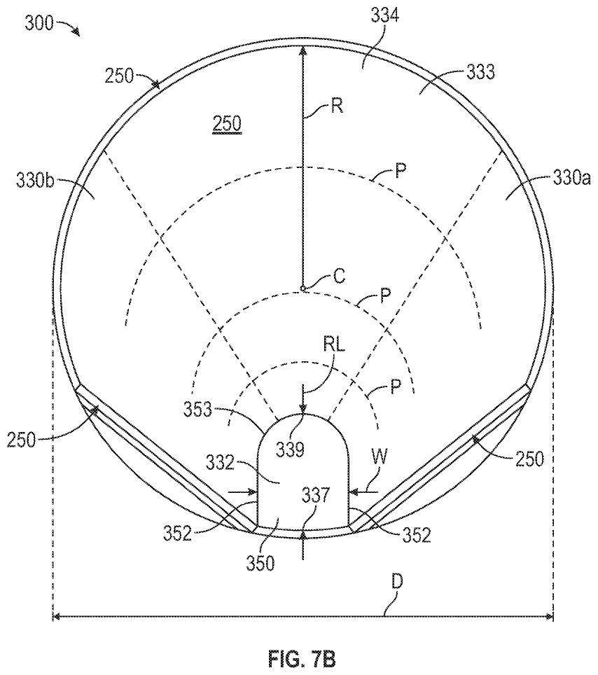

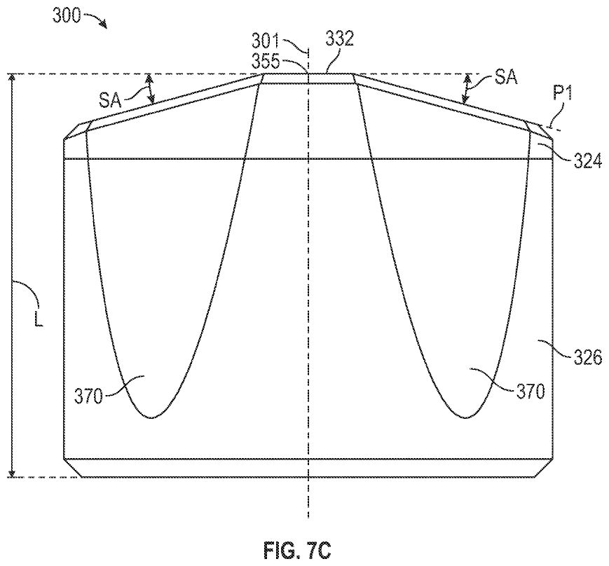

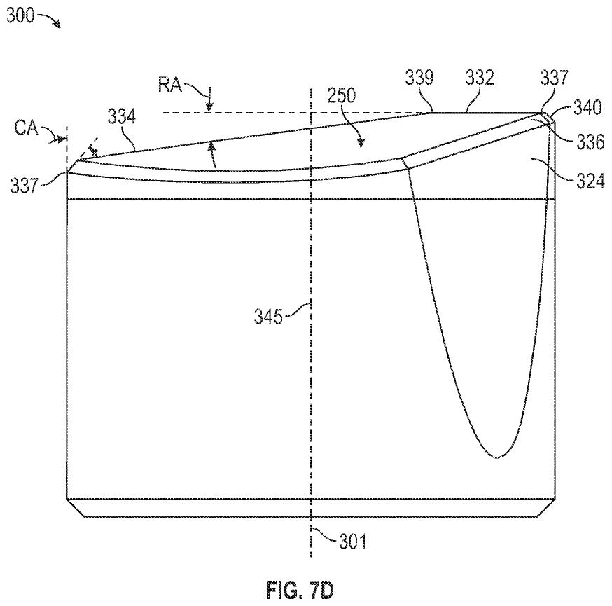

As described hereinabove, surface finish 250 can be applied to any one or more non-planar surfaces of cutting face 220 including chamfer 211, cutting regions 221a, 221b, 221c, and relief regions 222a, 222b, 222c. However, it should be appreciated that more generally, surface finish 250 can be applied to any non-planar surface on the cutting face of other cutter elements. For example, referring now to FIGS. 7A-7D, an embodiment of a cutter element 400 that can be used in place of cutter element 200 previously described is shown. As will be described in more detail below, cutter element 400 includes a non-planar cutting surface comprising a surface finish to reduce friction and drag.

Cutter element 300 includes a diamond (e.g., polycrystalline diamond (“PCD”)) layer 324 bonded to a less hard substrate 326 and a central axis 301. In the embodiment shown, cutter element 300 further includes a pair of planar faceted surfaces 370 (“facets”) extending through portions of both the PCD layer 324 and substrate 326. Facets 370 are formed at an angle relative to the cutter element's central axis 301 as best shown in FIG. 7C.

The substrate 326 may be made of tungsten carbide and the diamond layer may be formed of various materials including diamond. Part and/or all of the diamond layer may be leached, finished, polished, and/or otherwise treated to enhance durability, efficiency and/or effectiveness. When mounted to a bit body (e.g., bit body 110), cutter element 300 is positioned with PCD layer 324 is forward facing such that cutting face 328, at the exposed end of the cutter element 300, is positioned to engage formation material and form the wellbore.

Referring again to FIGS. 7A-7D, cutter element 300 includes a cutting face 328 having a ridge 332 that, in this embodiment, is elongated and planar on its uppermost surface 350. The planar surface 350 defines the highest or uppermost point of cutting face 328. Cutting face 328 further includes a non-planar and continuously curved surface 333 that makes up all of the cutting face 328 that is not part of ridge 332 and, in this way, is referred to herein as a surface that “surrounds” the ridge or as a “surrounding surface” 333. As used herein, the term “continuously curved” means and relates to surfaces that can be described as consisting of ridgeless surfaces that are free of abrupt changes in radii and free of relatively small radii (0.080 in. or smaller) as have conventionally been used in cutter elements to round off transitions between adjacent distinct surfaces or to “break” sharp edges. Surrounding surface 333 may be described as including a pair of side regions 330a,b and a ramp region 334. A chamfer 336 extends about the cutting face 328 and defines the periphery 338 of the cutting face 328.

Referring still to FIGS. 7A-7D, ridge 332 extends from an outermost end 337 in a direction towards the center C of the cutting face 328 and terminates in a central most end 339 that is curved. In this exemplary embodiment, ridge 332 extends along a plane 302 that bisects cutting face 328 and that contains central axis 301, plane 302 intersecting the periphery 338 at leading point 355 and trailing point 357. In other embodiments, ridge 332 may be offset from or skewed relative to bisecting plane 302. Ridge 332, like ramp region 334, separates the side regions 330a,b from one another. In this embodiment, ridge 332 extends in a direction that is generally perpendicular to the outer diameter (OD) of the cutter element 300 and extends between a pair of facets 370 that are positioned on either side of ridge 332. As best shown in the top view of FIG. 7B, one facet 370 is located on each side of ridge 332 and each extends through the PCD layer 324 and partially through the substrate 326. In this manner, the periphery 338 of the cutting surface is not entirely circular, but instead includes two linear edges 331 formed at the intersection of a side region 330a,b and the chamfer 336. Leading edge 340 is curved and follows the generally cylindrical shape of cutter element 300 in the embodiment shown in FIGS. 7A-7D. Also in this embodiment, the outermost ridge end 337 is positioned at leading edge 340, such that the ridge 332 extends all the way to the periphery 338; however, ridge 332 may be formed to have its outer end 337 spaced apart an offset distance from periphery 338. Side regions 330a,b extend from periphery 338 toward ridge 332 and also toward ramp region 334. Side regions 330a,b are non-planar and continuously curved. Ramp region 334 is also non-planar and continuously curved such that side regions 330a,b and ramp region 334 are thus free of planar areas (i.e. free of “flats”). As best shown in the front profile view of FIG. 7C, although continuously curved in the manner described above, side regions 330a,b present a linear profile that extends from ridge 332 to the periphery 338 at a slant angle SA of about 10 degrees in this exemplary embodiment. The slant angle may be between about 2 degrees to about 20 degrees in other embodiments, it may be still larger. As shown in FIG. 7C, the slant angle SA is the angle formed between a plane containing the upper planar surface 350 of ridge 332 and the side region 330a,b when viewed in a profile view looking along reference plane 302 toward leading point 355.

Referring now to FIG. 7D, although continuously curved, ramp region 334, in profile view, is linear from the ridge end 339 to periphery 338 and forms a ramp angle RA of about 7 to 10 degrees in the embodiment shown. In other embodiments the ramp angle RA may be from about 2 to 10 degrees. In other embodiments, the ramp angle may be greater than 10 degrees or less than 2 degrees. As shown in FIG. 7D, the ramp angle RA is the angle formed, in a profile view, between ramp region 334 and the planar surface 350 of ridge 332 when viewed perpendicular to reference plane 302 (FIG. 7A) and parallel to upper planar surface 350 of ridge 332.

To further explain the continuously curved characteristic of surrounding surface 333 and its constituent regions, it is to be understood that along the various curved paths P shown in FIG. 7C between ridge 332 and periphery 338, the surrounding surface 333 is both free of planar surfaces and free of abrupt changes in radii, including when moving on a path P from side region 330a (having a given slant angle) to ramp region 334 (having a ramp angle that, in this example, is different from the slant angle.) To further explain, and referring to FIG. 7B, the intersection of ridge 332 with surrounding surface 333 includes a pair of parallel sides 352 that are joined by a curved surface or segment 353. Considering a first line extending perpendicular from a side 352 and extending downward from ridge upper surface 350 at the slant angle previously defined, the side surface 330a may be visualized as being the surface formed as that line is moved or swept along the straight side 352. Likewise, considering a second line extending perpendicular to a tangent at a point along curve 353 and forming the ramp angle previously defined, the ramp region 334 may be visualized as being the surface formed as second that line (always kept perpendicular to a tangent) is swept along curved surface 353 from one side 352 to the other side 352. Although the slant angle and ramp angle are different, the transition between the different surfaces formed by the different line sweeps is nevertheless made gradually so that there are no ridges, discontinuities or abrupt changes in the surface 333, the surface instead being continuously curved as defined herein. Ramp region 334 extends from periphery 338 toward ridge 332 and extends between and separates side regions 330a,b. As best shown in FIGS. 7A and 7B, the side regions 330a,b are shown to be generally wedge shaped regions that are symmetrical relative to each other and that terminate at edges or sides generally represented by dashed lines 370a and 370b, respectively. However, lines 370a,b are depicted merely to help describe the spatial relationship of the side regions 330a,b relative to the ramp region 334, but do not represent ridges, valleys or any other discontinuity between ramp region 334 and the side regions 330a,b. Although lines 370a,b shown in FIGS. 7A, 7B represent general transitions between side regions 330a,b and ramp region 334, it is to be understood that the lines do not represent sharp transitions such as ridges or valleys. Instead, regions 330a,b and 334 are blended together to form the continuously curved surrounding surface 333 which are free from abrupt changes in radius.

In the exemplary embodiment shown ridge 332 extends from outer end 337 at leading edge 340 toward the center C of the cutting face 328, center C being contained in cutter axis 301. Ridge 332 thus extends along a portion of the diameter of the face 328, for example, extending for a length RL (FIG. 7B) from about 5% to about 50% of the diameter D of the face 328. A ridge length of about 20% D to about 40% D may be employed. In this manner, ridge 332 defines a protrusion extending from chamfer 336 at the periphery 338 to the central-most end 339 of the ridge. Ridge end 339 is curved where it intersects ramp region 334 in the embodiment shown. The ridge 332 may have a length that is predetermined to be best for physically splitting apart and extruding rock particles or extrudates and directing the smaller, split extrudate portions onto the side regions 330a,b. An exemplary length of ridge 332 from end 337 at periphery 338 to end 339 is about 8 mm for a cutter element having a diameter of about 16.1 mm.

In the embodiment shown in FIGS. 7A-7D, the planar top surface 350 of ridge 332 includes the highest point of the cutting face 328. In embodiments in which the ridge does not extend to the center C of the cutting face, the highest point of the cutting face is thus offset from the central cutter axis 301 and is not aligned with the center C. In some embodiments, such as where the ridge length RL 332 is less than 25% of the diameter D, the highest point in the cutting face is closer to the periphery 338 than it is to center C. In one example, the offset distance is 20% of D or more.

Further, in the embodiment shown in FIGS. 7A-7D, ridge 332 has a uniform width along its entire length. Ridge 332 may have a width W of, for example, about 0.50 mm. Ridge 332 may have a uniform height along the entire length thereof as shown in FIGS. 7A-7D, or may possess a height that varies, such as by having a height that increases from the end proximate leading edge 340 to central most end 339.

Chamfer 336 extends along periphery 338 and defines the leading edge 340 and linear edges 331. The leading edge 340 may be dimensioned to achieve a generally predetermined depth-of-cut into the formation. The chamfer 336 may extend around the periphery 338 at a chamfer angle CA (FIG. 7D) of about 45 degrees (or as desired from about 15 degrees to about 75 degrees).

As described above, in some embodiments, the slant angle and the ramp angle are different on a given cutter element. Given that each such angle is measured relative to the same planar upper surface 350 of ridge 332, the difference in slant angle vs. ramp angle will lead to different thicknesses of the PCD at the periphery 338 of the element's cutting face. This is best shown with reference to cutter element 300 depicted in FIGS. 7A-7D where ramp angle RA is less than slant angle SA. In this arrangement, the thickness of the diamond at trailing point 357 is greater than the thickness of the diamond at a point 345 (FIG. 7D) located along the periphery 338 and 90 degrees from the trailing point. By selecting various slant angles and ramp angles, the thickness of the PCD layer can be varied so as to best tailor a cutter element 300 to withstand expected forces, to have the required durability, to make the desired depth of cut, and to meet other particular cutting demands of a given drilling application. As such, depending on a cutter element's position in a drill bit, the slant and ramp angle may differ from cutter element to cutter element within the bit, as well as along the periphery of each cutter element.

In operation, cutter elements 300 are mounted to the blades of the bit body such that their leading edge 340 and the chamfer 336 engage formation material at the wall of the wellbore such that extrudate is drawn along the pair of side regions 330a,b while drilling. The leading edge 340 of the cutter elements(s) may engage and dislodge rock along the wellbore to form extrudates. The side regions (e.g., 330a,b) may direct opposing forces to extrudates at positive non-zero angles to the two-dimensional plane of the leading edge 340. These forces may urge the extrudates into the drilling fluid until such point in time when the surface area of each extrudate exceeds a critical value and the extrudate is broken off into the flow regime of the drilling fluid. The ramp (e.g., 334) may be used to guide or direct the drilling fluid toward the cutting face 328 to reduce interfacial friction between the working surface and rock extrudate and carry extrudate away as it is dislodged about the leading edge 340.

As described herein above, cutting face 328 includes a non-planar surface 333 and non-planar chamfer 336. In this embodiment, non-planar surface 333 and non-planar chamfer 336 comprise surface treatment 250 as previously described. In particular, surface treatment 250 is applied to the entirety of non-planar surface 333 and non-planar chamfer 336, thereby offering the potential to reduce friction between surface 333 and the formation being cut and reduce friction between chamfer 336 and the formation being cut.

In the manner described, surface treatments (e.g., surface treatment 250) are applied to one or more non-planar surfaces along the cutting face of a cutter element to reduce friction between such non-planar surface(s) and the formation being cut by reducing the surface area of the non-planar surface(s) that contacts the formation. By reducing the contact surface area and friction, such surface treatments offer the potential to enhance cutter element durability and ROP.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A cutter element for a drill bit configured to drill a borehole in a subterranean formation, the cutter element comprising:
a base portion having a central axis, a first end, a second end, and a radially outer surface extending axially from the first end to the second end; and
a cutting layer fixably mounted to the first end of the base portion, wherein the cutting layer includes a cutting face distal the base portion and a radially outer surface extending axially from the cutting face to the radially outer surface of the base portion;
wherein the cutting face includes a non-planar surface;
wherein the non-planar surface comprises a surface finish including a plurality of elongate raised ridges and a plurality of recesses positioned between the raised ridges.

2. The cutter element of claim 1, wherein each of the plurality of raised ridges has a linear central axis, a first end, a second end opposite the first end, a length measured axially from the first end to the second end, and a width measured perpendicular to the central axis;
wherein the plurality of raised ridges are oriented parallel to each other.

3. The cutter element of claim 2, wherein the plurality of raised ridges are arranged in a plurality of parallel rows.

4. The cutter element of claim 3, wherein the plurality of raised ridges include a first plurality of raised ridges axially spaced apart in a first row, a second plurality of raised ridges axially spaced apart in a second row, and a third plurality of raised ridges axially spaced apart in a third row.

5. The cutter element of claim 4, wherein the first plurality of raised ridges are axially aligned, the second plurality of raised ridges are axially aligned, and the third plurality of raised ridges are axially aligned.

6. The cutter element of claim 5, wherein the second row is laterally positioned between the first row and the third row, and wherein the first row is laterally spaced from the second row and the third row is laterally spaced from the second row.

7. The cutter element of claim 5, wherein the second row is laterally positioned between the first row and the third row, wherein a first recess of the plurality of recesses is positioned between the first row and the second row and a second recess of the plurality of recesses is positioned between the second row and the third row.

8. The cutter element of claim 7, wherein the first recess has a first width measured perpendicular to the central axes of the second plurality of raised ridges and the second recess has a second width measured perpendicular to the central axes of the second plurality of raised ridges.

9. The cutter element of claim 8, wherein the first width of the first recess is the same as the width of each raised ridge.

10. The cutter element of claim 9, wherein the first width is the same as the second width.

11. The cutter element of claim 4, wherein one of the plurality of recesses is positioned between each pair of axially adjacent raised ridges in the first row;
wherein one of the plurality of recesses is positioned between each pair of axially adjacent raised ridges in the second row; and
wherein one of the plurality of recesses is positioned between each pair of axially adjacent raised ridges in the third row;
wherein each of the recesses in the second row is axially staggered relative to each of the recesses in the first row and each of the recesses in the second row.

12. A cutter element for a drill bit configured to drill a borehole in a subterranean formation, the cutter element comprising:
a base portion having a central axis, a first end, a second end, and a radially outer surface extending axially from the first end to the second end; and
a cutting layer fixably mounted to the first end of the base portion, wherein the cutting layer includes a cutting face distal the base portion and a radially outer surface extending axially from the cutting face to the radially outer surface of the base portion;
wherein the cutting face includes a non-planar surface;
wherein the non-planar surface includes a surface finish comprising:
a plurality of elongate raised ridges arranged in a plurality of laterally spaced parallel rows;
a plurality of first recesses, wherein each first recess is positioned between a pair of laterally adjacent rows; and
a plurality of second recess, wherein each second recess is positioned between a pair of raised ridges in each row.

13. The cutter element of claim 12, wherein each of the plurality of raised ridges has a linear central axis, a first end, a second end opposite the first end, a length measured axially from the first end to the second end, and a width measured perpendicular to the central axis;
wherein the raised ridges in each row are axially aligned.

14. The cutter element of claim 12, wherein each first recess has a first width measured perpendicular to the central axes of the corresponding pair of laterally adjacent rows and each second recess has a second width measured perpendicular to the central axes of the corresponding raised ridges in the same row.

15. The cutter element of claim 14, wherein the first width of each first recess is the same as the width of each raised ridge.

16. The cutter element of claim 15, wherein the first width of each first recess is the same as the second width of each second recess.

17. The cutter element of claim 12, wherein the non-planar surface is a bevel disposed about a radially outer periphery of the cutting face.

18. The cutter element of claim 12, wherein the non-planar surface is a concave or a convex surface.

19. The cutter element of claim 12, wherein the plurality of raised ridges include a first plurality of raised ridges axially spaced apart in a first row, a second plurality of raised ridges axially spaced apart in a second row, and a third plurality of raised ridges axially spaced apart in a third row.

20. The cutter element of claim 19, wherein the first plurality of raised ridges are axially aligned, the second plurality of raised ridges are axially aligned, and the third plurality of raised ridges are axially aligned.
